(19) United States
(12) Patent Application Publication
(10) Pub. No.: US 2019/0177528 A1
(43) Pub. Date: Jun. 13, 2019

(54) CROSS-LINKING AGENT COMPOSITION FOR ELASTOMERS

(71) Applicant: ElringKlinger AG, Dettingen (DE)

(72) Inventor: Roy Hornig, Bad Urach (DE)

(21) Appl. No.: 16/278,439

(22) Filed: Feb. 18, 2019

Related U.S. Application Data
(63) Continuation of application No. PCT/EP2017/068090, filed on Jul. 18, 2017.

(30) Foreign Application Priority Data
Aug. 19, 2016 (DE) 10 2016 115 464.4

(51) Int. Cl. C08L 33/08; C08K 5/00; C08K 5/17

(52) U.S. Cl. CPC C08L 33/08; C08K 2201/014; C08K 5/17; C08K 5/0025

(57) ABSTRACT

A cross-linking agent composition including a diamine cross-linking agent, which composition achieves comparable or better values in the ratio of the maximum achievable elongation at break to the heat compression set level in comparison to cross-linking agent compositions having a guanidine accelerator, even with high filler contents of the elastomer materials, includes a diamine cross-linking agent, an accelerator of the type of the 1,8-diazabicyclo[5,4,0]undec-7-ene (DBU), an activator of the pyrrolidone type, as well as a secondary aliphatic amine and/or a tertiary aliphatic amine.

### CROSS-REFERENCE TO RELATED APPLICATIONS

This application is a continuation of international application number PCT/EP2017/068090 filed on 18 Jul. 2017 and claims the benefit of German application number DE 10 2016 115 464.4 filed on 19 Aug. 2016, which are incorporated herein by reference in their entirety and for all purposes.

### BACKGROUND OF THE INVENTION

The invention relates to cross-linking agent compositions for elastomers which can be diamine cross-linked.

Such elastomers comprise one or more of the elastomers from the group of hydrogenated acrylonitrile butadiene rubber (HNBR), acrylate rubber (ACM), ethylene acrylate copolymer (EACM), also called ethylene acrylate rubber (AEM), vinyl acetate ethylene acrylate rubber (DENKA), as well as diamine cross-linkable fluorocarbon rubber (FKM).

In the past, good cross-linking results were achieved in elastomer materials based on the aforementioned elastomers with guanidine accelerator systems, in particular N,N′-di-o-tolylguanidine (DOTG). Poor value levels with regard to the elongation at break result in the case compression set values were optimized in mixtures, in particular also in the case of elastomer materials with high filler contents.

The guanidine accelerators have come under criticism due to the potentially cancer-causing byproducts contained therein, such that a cross-linking agent composition with accelerators on the basis of 1,8-diazabicyclo[5,4,0]undec-7-ene (DBU) in combination with various activators has been focused on as an alternative. An example for this is found in DE 10 2008 020 196 A1.

However, these alternative cross-linking agent compositions are disadvantageous in the case of elastomer materials with high amounts of fillers, to the extent that, in comparison to the previously used cross-linking agent compositions with guanidine accelerators, less balanced technical properties are obtained, in particular with respect to the balancing of elongation at break and compression set.

Experience with DBU-based cross-linking agent compositions shows that, in order to obtain good compression set values with the cross-linking agent compositions which contain accelerators on DBU-basis, relatively high cross-linking densities are necessary, which are reflected in decreasing elongation at break values (DIN 53504S2).

Cross-linking agent compositions for elastomer materials are known from U.S. patent application US 2012/0088887 A1, in which materials DOTG-accelerators have been replaced by a pure mixture of aldehyde amine condensation products and aliphatic amines. In these cross-linking agent compositions, it is disadvantageous that the elastomer materials cross-linked therewith have too high a heat compression set, as measured according to ISO 815, Part 1 and 2.

An object of the present invention is therefore to propose a cross-linking agent composition having a diamine cross-linking agent, which composition achieves comparable or better values in the ratio of the maximum achievable elongation at break to the heat compression set level in comparison to the cross-linking agent compositions having a guanidine accelerator, even with high filler contents of the elastomer materials.

### SUMMARY OF THE INVENTION

This object is achieved in accordance with the invention by a cross-linking agent composition having the features of claim 1.

The cross-linking agent compositions in accordance with the invention are suitable in particular for cross-linking diamine cross-linkable elastomer materials, in particular elastomer materials which contain the elastomers mentioned at the outset.

Furthermore, the invention relates to elastomer materials having a cross-linking agent composition in accordance with the invention, as well as gaskets having an elastomer gasket element, which gaskets are produced using the elastomer materials in accordance with the invention.

The individual aspects of the present invention are laid out in more detail in the following:

The cross-linking agent compositions in accordance with the invention may be put into practice with a wide range of diamine cross-linkers. Particularly preferable diamine cross-linking agents are selected from hexamethylene diamine carbamate, N,N-dicinnamylidene diamine carbamate, 4,4-diaminodicyclohexylmethane, 4,4-diaminodiphenylether, 2,2-bis[4-(4-aminophenoxy)phenyl]propane, as well as hexamethylene diamines.

The activator of the pyrrolidone type is selected in particular from 2-pyrrolidone, N-methylpyrrolidone, and polyvinylpyrrolidone.

The aliphatic amine is ultimately selected from secondary amines and tertiary amines, as well as mixtures thereof.

Preferred examples for secondary and tertiary amines comprise fatty acid amines, in particular di-coco-alkyl amine (DCAA), di-(hydrogenated tallow fat)-amine (BHTAA), and di-stearylamine, behenyl-dimethylamine, octadecyl-dimethylamine, di-coco-alkyl methyl amine (DCMAA), di-(hydrogenated tallow fat)-methyl-amine (BHTMAA), and di(hydrogenated tallow fat)-secondary-alkyl amine (BHTAsA) (obtainable as Aldogen 343HP from Evonik), as well as the tri-hexadecylamine (obtainable as Armeen 316 from AkzoNobel).

Furthermore, aldehydic amines in combination with the aliphatic amines are suitable as an additive to the accelerator containing DBU.

Aldehydic amines comprise the 3,5-diethyl-1,2-dihydro-1-phenyl-2-propyl-pyridine (PDHP), condensation products from butyraldehyde and aniline (B-a-rxn) and condensation products from butyraldehyde and butylamine.

The accelerator of the DBU type may be used, e.g., in the form of Vulcofac ACT 55, Vulcofac ACT 66, or ALCANPOUDRE DBU-70 (all these DBU types are obtainable from Safic-Alcan Deutschland GmbH). Furthermore, DBU accelerators, which are offered on the market together with a moderator, for example Rhenogran XLA 60, which contains zinc dithiophosphate (ZnDTP) as a moderator (obtainable from Rheinchemie), Luvomaxx Safe Cure CA, which contains a basic moderator (obtainable from Lehmann & Voss), as well as Accelor 50 (obtainable from SEC), which contains a DBU accelerator in admixture with NPC 50 (a quaternary ammonium compound, obtainable from ZEON Chemicals) as a moderator.

The elastomers stated at the outset are preferably used, individually or in a mixture with each other, in the elastomer materials in accordance with the invention.

In the AEM and ACM elastomers, those are preferred which comprise cure site monomer units which are accessible to the diamine cross-linking, of which units the content in the elastomers is preferably about 1 to about 5% by weight, further preferably about 2 to about 3% by weight.

Preferred AEM elastomers are, e.g., obtainable under the name VAMAC® from DuPont, in particular from the VAMAC VMX 5000 series, for example VMX 5020 and VMX 5015.

Preferred ACM elastomers are distributed by Zeon Chemicals under the trade name Nipol® and HyTemp®. Moreover, Tohpe Corporation, Unimatec (Noxtite) and Nippon Mechtronic offer diamine cross-linkable ACM elastomers of the diamine cross-linkable type.

Particularly preferably, the accelerator of the DBU type will be present in the elastomer materials in accordance with the invention in an amount of about 1 to about 10 phr (phr=parts per hundred rubber), preferably about 2 to about 4 phr.

The amount by weight of the activator of the pyrrolidone type in the cross-linking agent composition in accordance with the invention is, in relation to the amount of the accelerator of the DBU type, preferably about 10 to about 50% by weight.

The weight ratio of the accelerator of the DBU type to the sum of the amounts of the aliphatic and, as the case may be, aldehydic amines added in accordance with the invention in the cross-linking agent composition in accordance with the invention is preferably about 25:75 to about 99:1, further preferably about 40:60 to about 60:40.

The amount by weight of the aliphatic amine or the aliphatic amines (secondary and/or tertiary amines) in the elastomer material is preferably about 0.1 phr to about 2.9 phr, further preferably about 1 phr to about 1.5 phr.

The cross-linking agent, for example hexamethylene diamine carbamate (HMDC) is present in the elastomer material in accordance with the invention in a concentration of about 1 phr to about 4 phr, preferably about 1.5 phr to about 2.5 phr.

Alternatively, 1,6-hexamethylene diamine (HMD, CAS 124-09-4, for example obtainable as ADVANCURE from Chem Technologies, Ltd.) or an aromatic amine, e.g., 2,2-(4-(4-aminophenoxy)phenyl)propane (contained in Cheminox CLP 5250 to the amount of 50% by weight; obtainable from UNIMATEC Chemicals Europe GmbH & Co. KG) may also be used in the quantity ratios specified above.

The elastomer materials in accordance with the invention contain in particular a filler in an amount of about 50 phr or more. The filler amount will preferably be about 120 phr or less.

Preferred fillers of the elastomer materials in accordance with the invention are selected from inactive to active carbon black types, light fillers like, e.g., silicas, kaolins, mica, feldspar, talc, calcium carbonate, quartz, diatomaceous earth, cristobalite, barium sulfate (in naturally occurring or precipitated form).

Moreover, the elastomer materials in accordance with the invention may contain conventional additives like, e.g., processing aids, plasticisers, etc.

The invention finally relates to, as mentioned at the outset, gaskets comprising an elastomer gasket element which is produced using the elastomer composition in accordance with the invention.

The gasket may hereby comprise a support on which the elastomer gasket element is arranged.

Furthermore, the gasket in accordance with the invention may comprise a support which is partially or entirely enclosed by the elastomer gasket element.

With the elastomer materials in accordance with the invention, typical binder systems may be used for the chemical bonding of elastomer materials to metal substrates, like, e.g., silane phenolic resin blends (obtainable as Chemosil or Chemlok 512).

Finally, the present invention makes gaskets possible in which the gasket is formed substantially of the elastomer gasket element.

In addition, the present invention may be used for gasket systems in which adjoining gasket segments which are formed, on the one hand, by bisphenolically or diamine cross-linking FKM-mixtures and, on the other hand, by the aforementioned elastomer materials, are chemically bonded to each other, and thus in the various gasket segments different materials cover the different requirements for the overall gasket, as is known per se from DE 10 2007 032 149 A1.

The gaskets of the present invention are used, e.g., as an oil pan gasket. Moreover, hose materials for the fuel sector or exhaust gas gaskets, for example membranes, gaskets in the suction and valve cover field, valve flaps and connectors, transmission control pistons, control housing gaskets, oil gaskets on the transmission housing, toothed belts, and decoupling elements may also be produced with the elastomer materials in accordance with the invention.

This shows that the gaskets in accordance with the invention are producible with the elastomer materials in accordance with the invention for a wide range of fields of application with optimized properties in each case.

The invention is explained in more detail in the following with reference to the examples.

### BRIEF DESCRIPTION OF THE DRAWING

FIG. 1 shows heat compression sets for Example 2A and Example 2B as a function of the storage time.

### DETAILED DESCRIPTION OF THE INVENTION

### Examples

### Example 1

According to a first example, various exemplary compositions are used on the basis of an AEM elastomer of 50 parts by weight Vamac G and 50 parts by weight Vamac ULTRA IP (=together 100 parts by weight elastomer; both materials obtainable from DuPont) with 55 phr filler in the form of carbon black N772 as well as various cross-linking agent compositions as listed in detail in the following Table 1.

Further, all exemplary formulas contain the following additives:

1 phr stearic acid as processing aid

15 phr plasticiser (Bisoflex T810T, trimellitic acid ester CAS 67989-23-5),

1 phr polyoxyethylene octadecyletherphosphate (VANFRE VAM; CAS 62362-49-6) as internal release agent,

0.5 phr octadecylamine as flow aid, and

2 phr dicumyl diphenylamine (CAS 10081-67-1; obtainable as Dusantox 86 from Duslo a.s.) as antioxidant.

The Vulcofac ACT66 (obtainable from Safic-Alcan) contains, in addition to the accelerator DBU (amount by weight 52.5%) 2-pyrrolidone as an activator in an amount of 17.5% by weight.

TABLE 1

| Example | 1A | 1B | 1C | 1D |
|---|---|---|---|---|
| Vulcofac ACT66 [phr] | — | 1.5 | 2.0 | 3.0 |
| (DBU content) [phr] | (—) | (0.788) | (1.05) | (1.575) |
| (2-pyrrolidone content) [phr] | (—) | (0.263) | (0.35) | (0.525) |
| Aliphatic amine | 6.0 | 3.0 | 2.0 | — |
| BHTAA 50% [phr] | | | | |
| (BHTAA content) [phr] | (3.0) | (1.5) | (1.0) | (—) |
| HMDC 70% by weight [phr] | 2.3 | 2.3 | 2.3 | 2.3 |
| (HMDC content) [phr] | (1.61) | (1.61) | (1.61) | (1.61) |

After mixing the composition ingredients, the elastomer materials thus obtained were subject to cross-linking on a test plate press at 180° C. for 10 min and a pressure of 180 bar and then a pressureless post-tempering in the convection oven at 185° C. for 3 h and processed to test pieces.

The measurement values for the Shore hardness A, the elongation at break, and the heat compression set were determined and are contained in the following Table 2.

TABLE 2

| Example | 1A | 1B | 1C | 1D |
|---|---|---|---|---|
| Shore hardness A | 53.8 | 56.9 | 57.3 | 59.2 |
| Elongation at break [%] | 385 | 327 | 311 | 271 |
| Heat compression set [%] | 30.2 | 26.8 | 25.0 | 26.0 |

The shore hardness A was determined according to DIN EN ISO 868 and the elongation at break in accordance with DIN 53504S2.

The heat compression set was measured according to ISO 815, Part 1 and 2 (test piece type B) after storage for 24 h at 150° C. in hot air with a compressive deformation path of 25% (in relation to the test piece thickness) after demolding in the cold state at 23° C. The measurement of the thickness of the test pieces took place 30 min after the demolding.

As the comparison of the data from Examples 1A and 1D (reference) to the data from the Examples 1B and 1C in accordance with the invention shows, good, balanced data both for the elongation at break and for the heat compression set result in the case of cross-linking agent compositions in accordance with the invention, while with the Reference Example 1A, one does indeed observe a very good elongation at break, but a higher heat compression set as well as a lower Shore hardness A.

### Example 2

According to a second example, the exemplary compositions contain an AEM elastomer of 100 parts by weight Vamac G and a high filler amount in the form of carbon black N772 (75 phr) and carbon black N550 (15 phr), i.e., in the sum of in total 90 phr, as well as cross-linking agent compositions as listed in detail in the following Table 3.

Further, all exemplary formulations contain the following additives:

2 phr stearic acid as processing aid,

15 phr plasticiser (Bisoflex T810T, trimellitic acid ester CAS 67989-23-5),

1 phr polyoxyethylene octadecyletherphosphate (VANFRE VAM; CAS 62362-49-6) as internal release agent,

0.5 phr octadecylamine as flow aid, and

2 phr dicumyl diphenylamine (CAS 10081-67-1; obtainable as Dusantox 86 from Duslo a.s.) as antioxidant.

The Vulcofac ACT66 (obtainable from Safic-Alcan) contains, in addition to the accelerator DBU (amount by weight 52.5%), 2-pyrrolidone as an activator in an amount of 17.5% by weight.

After mixing the composition ingredients, the elastomer materials thus obtained were subject to cross-linking on a test plate press at 180° C. for 10 min and a pressure of 180 bar and then a pressureless post-tempering at 185° C. for 3h in the convection oven and processed to test pieces.

TABLE 3

| Example | 2A | 2B |
|---|---|---|
| Vulcofac ACT66 [phr] | 3 | — |
| (DBU content) [phr] | (1.575) | (—) |
| (2-pyrrolidone content) [phr] | (0.525) | (—) |
| Aliphatic amine BHTAA 50% [phr] | — | 6.0 |
| (BHTAA content) [phr] | (—) | (3.0) |
| HMDC 70% [phr] | 2.5 | 2.5 |
| (HMDC content) [phr] | (1.75) | (1.75) |
| Shore hardness A | 78.1 | 70.5 |
| Elongation at break [%] | 164 | 239 |

The data for the Shore hardness A and the elongation at break are specified in Table 3. The Shore hardness A was again determined in accordance with DIN EN ISO 868 and the elongation at break in accordance with DIN 53504S2.

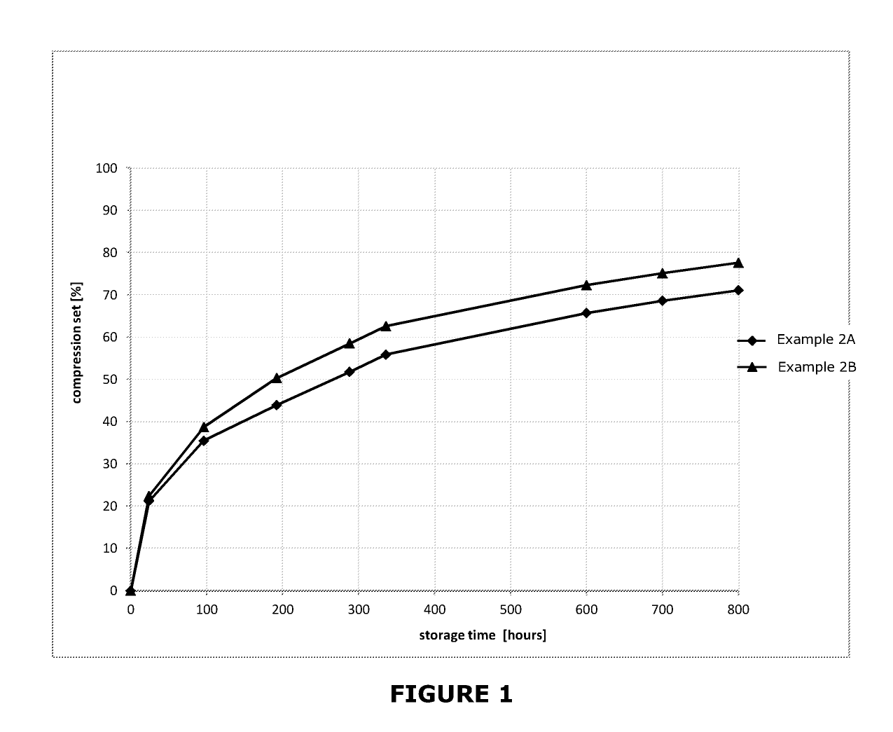

The heat compression set was determined in accordance with ISO 815, Part 1 and 2 (test piece type B) after a storage at 175° C. in hot air with a compressive deformation path of 25% (in relation to the test piece thickness) after the demolding in the hot state. The measurement of the thickness of the test pieces took place 30 min after the demolding at 23° C. The values for the heat compression sets thus achieved in the long-term test are depicted in FIG. 1 as a function of the storage time.

In the reference composition 2A, the heat compression set is significantly and, above all, long-lastingly lower than in the reference composition 2B, wherein the reference formulation 2B has a significantly higher elongation at break.

This shows, as Examples 1A to 1D have already shown, the advantages of compositions balanced in accordance with the invention, which contain both a secondary and/or tertiary aliphatic amine (e.g. BHTAA) and an accelerator of the DBU type together with the pyrrolidone activator (e.g. in the form of Vulcofac ACT 66). For the data regarding the Shore hardness A, the elongation at break, and the heat compression set are between the extremes of the Examples 2A and 2B in formulas in accordance with the invention.

Example 2 shows that even if very high filler contents are present in the elastomer material (presently 90 phr), advantageously balanced properties are achievable. As expected, these advantages are also given for the compression set in the case of a demolding in the hot state.

The smaller elongation at break values in the case of composition 2A are able to be compensated by a convergence of the composition with the composition 2B through the addition in accordance with the invention of an amount of a secondary and/or tertiary amine (e.g. BHTAA). For this purpose, the secondary and/or tertiary amine is preferably used in the elastomer material in an amount of about 0.1 phr to about 2.9 phr, further preferably of about 1 phr to about 1.5 phr.

A balanced ratio of, e.g., BHTAA as aliphatic amine, on the one hand, and, e.g., ACT66 (DBU amount and pyrrolidone component), on the other hand, lead to the optimal compromise of low heat compression set values and high elongation at break values, as is apparent from Examples 1B and 1C. Such optimal results are, in accordance with the invention, also achievable with the high filler contents and the correspondingly high Shore hardness A values of Examples 2A and 2B with corresponding amounts of the DBU accelerator, the pyrrolidone activator, and the aliphatic amine component.

1. A cross-linking agent composition for elastomer materials, comprising a diamine cross-linking agent, an accelerator of the type of the 1,8-diazabicyclo[5,4,0]undec-7-ene (DBU), an activator of the pyrrolidone type, as well as a secondary aliphatic amine and/or a tertiary aliphatic amine.

2. The cross-linking agent composition in accordance with claim 1, wherein the composition additionally comprises an aldehydic amine, wherein the weight ratio of the accelerator of the DBU type to the sum of the amounts of the aliphatic and, optionally, aldehydic amines in the cross-linking agent composition is preferably about 25:75 to about 99:1.

3. The cross-linking agent composition in accordance with claim 1, wherein the diamine cross-linking agent is selected from hexamethylene diamine carbamate, N,N-dicinnamylidene diamine carbamate, 4,4-diaminodicyclohexylmethane, m-xylylenediamine, 4,4-diaminodiphenylmethane, 4,4-diaminodiphenylether, 2,2-bis[4-(4-aminophenoxy)phenyl]propane, as well as hexamethylenediamine.

4. The cross-linking agent composition in accordance with claim 1, wherein the amount by weight of the activator of the pyrrolidone type in relation to the amount of the accelerator of the DBU type in the cross-linking agent composition is about 15% by weight to about 50% by weight.

5. The cross-linking agent composition in accordance with claim 1, wherein the aliphatic amine is selected from secondary amines, in particular secondary fatty acid alkyl amines, preferably di-coco-alkylamine (DCAA), di-(hydrogenated tallow fat)-amine, bis(hydrogenated tallow alkyl) amine (BHTAA), and di-stearylamine, as well as tertiary amines, in particular behenyl-dimethylamine, octadecyl-dimethylamine, di-coco-alkyl methylamine (DCMAA), di-hydrogenated tallow fat methyl amine (BHTMAA), di-hydrogenated tallow fat-secondary-alkylamine (BHTAsA), tri-hexadecylamine, or mixtures of the aforementioned amines.

6. The cross-linking agent composition in accordance with claim 2, wherein the aldehydic amine is selected from 3,5-diethyl-1,2-dihydro-1-phenyl-2-propyl-pyridine (PDHP), condensation products from butyraldehyde and aniline and condensation products from butyraldehyde and butylamine.

7. An elastomer material comprising one or more of the elastomers of the group HNBR, ACM, EACM, DENKA, and FKM, as well as a cross-linking agent composition according claim 1.

8. The elastomer material in accordance with claim 7, wherein the amount of the accelerator of the DBU type in the elastomer material is about 1 phr to about 10 phr, preferably about 2 phr to about 4 phr.

9. The elastomer material in accordance with claim 7, wherein the diamine cross-linking agent in the elastomer material is present in an amount of about 1 phr to about 4 phr, preferably about 1.5 phr to about 2.5 phr.

10. The elastomer material in accordance with claim 7, wherein the amount of the secondary aliphatic and/or tertiary aliphatic amine or the amines in the elastomer material is about 0.1 phr to about 2.9 phr, preferably about 1 phr to about 1.5 phr.

11. The elastomer material in accordance with claim 7, wherein the elastomer material contains one or more fillers, wherein the filler or fillers are preferably selected from inactive to active carbon black types or light fillers, in particular silicas, kaolins, mica, feldspar, talc, calcium carbonate, quartz, diatomaceous earth, cristobalite, barium sulfate (in naturally occurring or precipitated form).

12. The elastomer material in accordance with claim 11, wherein the amount of the filler or fillers in the elastomer material is about 50 phr or more, preferably less than about 120 phr.

13. A gasket comprising an elastomer gasket element produced using an elastomer material in accordance with claim 7.

14. The gasket in accordance with claim 13, wherein the gasket comprises a support on which the elastomer gasket element is arranged.

15. The gasket in accordance with claim 13, wherein the gasket comprises a support which is partially or entirely enclosed by the elastomer gasket element.

16. The gasket in accordance with claim 13, wherein the gasket substantially consists of the elastomer gasket element.

17. The gasket in accordance with claim 13, wherein the gasket is configured as an oil pan gasket or as an exhaust gas gasket.

18. A fuel line produced using an elastomer material in accordance with claim 7.
